(19) United States
(12) Patent Application Publication
(10) Pub. No.: US 2015/0178374 A1
(43) Pub. Date: Jun. 25, 2015

(54) METHOD AND SYSTEM OF PROVIDING USER PROFILE DETECTION FROM AN INPUT DEVICE

(71) Applicant: TRUSTEER LTD., Tel Aviv (IL)

(72) Inventors: Ofer Rahat, Netanya (IL); Ron Peleg, Kfar Bilu (IL); Ayman Jarrous, Haifa (IL); Shmuel Regev, Tel Aviv (IL)

(73) Assignee: TRUSTEER LTD., Tel Aviv (IL)

(21) Appl. No.: 14/139,066

(22) Filed: Dec. 23, 2013

(51) Int. Cl. G06F 17/30

(52) U.S. Cl. CPC G06F 17/30598

(57) ABSTRACT

The present disclosure relates to a method of providing user categorization from computer pointer interaction, comprising the steps of: creating a plurality of different pointer data profiles based on initial user sessions and storing said created pointer data profiles in the form of pointer data profile entries in a pointer data profile database, wherein said pointer data profile is obtained from collected user activity data generated by a pointing device; and categorizing each user using the stored pointer data profiles at an onset of subsequent user sessions.

### FIELD OF THE DISCLOSURE

The present disclosure relates to the field of software security. More particularly, the disclosure relates to a method providing user profile detection from a pointing device.

### BACKGROUND OF THE DISCLOSURE

There is no current way to detect and identify beyond doubt an identity for continuous usage of an endpoint user of a computer, or any web device e.g. a PC, laptop or tablet, etc. at any given moment.

After gaining entrance to the computer using some means of identification, for example, by requesting a password to be entered, it is impossible to verify that the user that provided the password (i.e., the user that operates the input devices such as the keyboard and mouse) is indeed the authorized person. For example, one serious threat is phishing wherein the credentials of a user are stolen and later attempted to be used by a fraudster.

Having someone's credentials, a fraudster can easily access any system without the permission or sometimes even the knowledge of the person whom the credentials are belongs to.

Accordingly, the present disclosure provides system and methods for detecting pointer interaction behavior associated with a user.

The present disclosure may provide systems and methods for preventing the theft of user identity.

Other objects and advantages of the disclosure will become apparent as the description proceeds.

### SUMMARY OF THE DISCLOSURE

In one aspect the disclosure relates to a computerized method of providing user categorization from computer pointer interaction, comprising the steps of: creating, using at least one computer, a plurality of different pointer data profiles based on initial user sessions and storing the created pointer data profiles in the form of pointer data profile entries in a pointer data profile database connected to the at least one computer, where the pointer data profile is obtained from collected user activity data generated by an input/output device, such as, for example, a pointing device; and categorizing each user using the stored pointer data profiles at an onset of subsequent user sessions.

According to an example embodiment, the method further comprises continuously performing user categorization during subsequent user sessions and during further user sessions. The method may update stored data profiles with data gathered during each user session.

According to an example embodiment, the categorization is used for controlling certain types of computerized access.

According to an example embodiment, the collected user activity data are parameters that represent raw input device (e.g., mouse touch screen, roller ball, etc.) movement events and raw input device (e.g., mouse, touch screen, rollerball, etc.) operation events.

Example embodiments may include a non-transitory computer readable medium that stores instruction executable by one or more processors to perform a method of providing user categorization from a pointing device, comprising: instructions for creating a plurality of pointer data profiles based on initial user sessions and storing said created pointer data profiles in the form of pointer data profile entries in a pointer data profile database; and instructions for categorization of each user using the stored pointer data profiles at an onset of subsequent user sessions.

### BRIEF DESCRIPTION OF THE DRAWING

FIG. 1 shows a flow chart of a method for monitoring and comparing the pointer interaction, in accordance with an example embodiment; and

FIG. 2 shows a computer system which provides user authentication from the computer pointer interactions, according to an example embodiment.

### DETAILED DESCRIPTION OF THE DISCLOSURE

An example embodiment of the present disclosure may provide user categorization from computer pointer interaction. Such pointer interaction (e.g., mouse, touch screen, touch pad, trackball movement events) can be collected from a standard pointing device such as a computer mouse, a touch-based track pad, a trackball, a scroll wheel, or the like. Initially, a user profile is created from pointer input collected when a user operates a pointing device. Then, during a subsequent user session, further pointer input collected from the pointing device during that subsequent session is compared to the user profile to categorize the user.

According to an example embodiment, each user's behavior is categorized into a “bucket” (e.g., one of 100 or 1000 possible buckets). Thus, it is assumed that the same user will be assigned the same bucket. However, each bucket is likely to be assigned to thousands, maybe even more, users. But the likelihood of the attacker to fall into the same bucket with the genuine user is 1:100-1:1000, which dramatically reduces fraud.

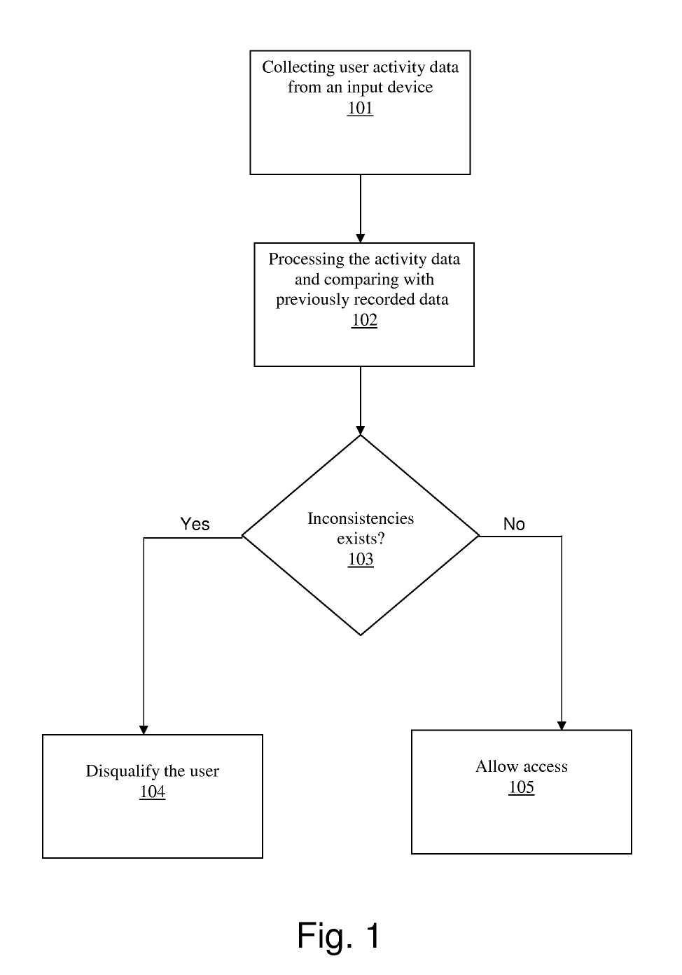

FIG. 1 shows a flow chart of a method for monitoring and comparing the pointer interaction, in accordance with an example embodiment. The process for monitoring and comparison of pointer interaction to a computer can be implemented by program module(s). As used herein, the term “module” may be understood to refer to computer executable software, firmware, hardware, or various combinations thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

The exemplary modules may perform the following steps: collecting user activity data (101) as obtained from one or more tasks such as tracking movements of a computer mouse or other input device. For example, monitoring may include monitoring clicking timing (e.g., of right and left mouse buttons), movement speeds, force applied, and the like. Exemplary modules may then process the collected activity data (102) and compare it with the activity data as was previously recorded and processed with respect to an expected category that roughly represents a user profile. For example, the process activity data may reflect a standard deviation as obtained from user listed profile and from current collected activity data. If the process activity data includes inconsistencies after the program has carried out its comparisons (103), the system may disqualify the user (104). Once a potential fraud is identified, the system may take any suitable action, such as alerting a user (e.g., sending e-mail), locking the terminal device, blocking access to an online account, taking a photo if a built-in camera exist, and/or the like. All actions are conventional and well known to the skilled person and, therefore, are not described herein in detail. If authentication is successful, the modules may allow access (105) e.g., to a computer, an application, and/or an online user account.

Each category may be defined by parameters received from an input device of a computer system, which may include raw input device movements and operation events that may include: average time between clicks; duration for which the buttons are pressed, direction of movements, movement rates, etc. Other parameters may include, for example, force used on a touch screen or pad, and the like. For example, a user may operate a pointing device slowly and deliberately as opposed to quickly and sporadically. Similarly, a user may tend to move the pointing device in straight lines or in arcs, and so on. Such types of pointing device operation provide distinct ways of identifying the user.

The following discussions are intended to provide a brief, general description of a suitable computing environment in which example embodiments may be implemented. While the embodiments may be described in the general context of program modules that execute in conjunction with an application program that runs on an operating system on a personal computer, those skilled in the art will recognize that the example embodiments may also be implemented in combination with other program modules.

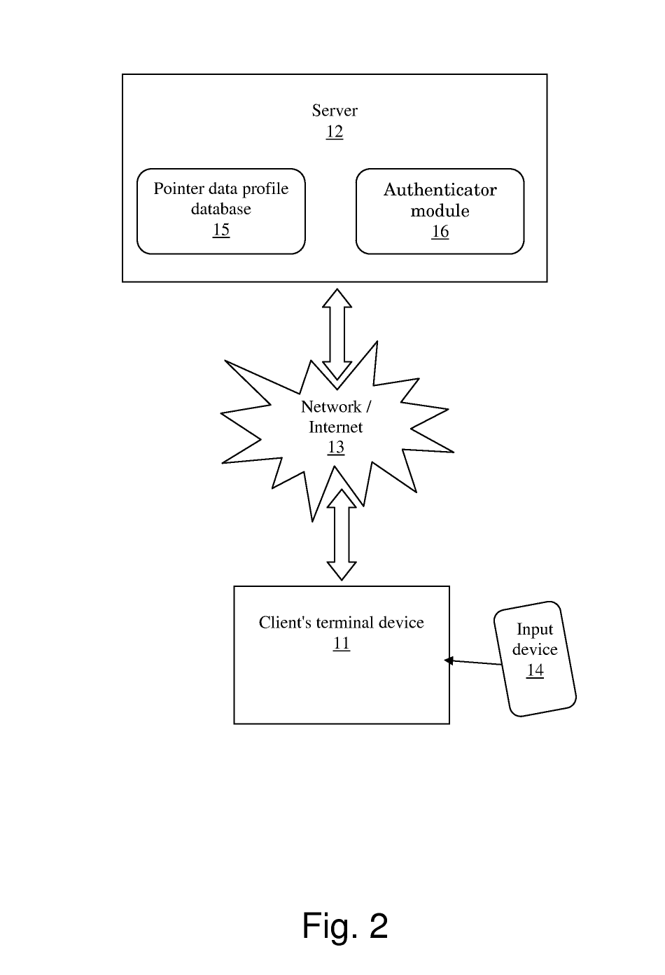

FIG. 2 shows a computer system 10 which provides user categorization from computer pointer interactions, according to an example embodiment. The computer system 10 includes client's terminal device 11, a server 12, and a computer network 13 which enables the terminal device 11 and the server 12 to communicate with each other via any suitable communication protocol.

The terminal device 11 includes common elements such as a network interface, user input/output (I/O) components which includes, for example an input device such as a pointing device 14, a processing circuitry, and the like.

According to an embodiment, the server 12 may include a pointer data profile database 15 and a categorization module 16. In addition the server 12 may include common elements such as a network interface, a processing circuitry, and the like. The pointer data profile database 15 may include multiple pointer data profile entries to support multiple users.

The user I/O components of the terminal device 11 may receive user input and provide user output enabling a user to effectively and efficiently operate the terminal device 11. In particular, the pointing device 14 may receive pointer input from the user in order to direct movement of a pointer graphic on an electronic display.

The terminal device 11 may perform operations enabling the user to perform useful work and/or derive entertainment (e.g., to run user-level applications, to access websites online, etc.). The terminal device 11 may be constructed and arranged to collect pointer data from the pointing device 14, and provides that pointer data to the server 12. For example, an event collector circuitry (not shown), which preferably runs in the background so that its operation is substantially transparent to the user, can be utilized to collect the pointer data.

In one embodiment, input device data may be collected during a user's browsing session in a participating site, by that site serving special content (Javascript code) in one or more pages the user navigates to. The Javascript code may collect information about input device movements (in the form of DOM events—e.g., onMouseMove, onMouseDown and onMouseUp) in the context of the rendered page.

As aforementioned hereinabove, the pointer data may include a sequence of, for example, raw input device movement events (e.g., sampled pointer locations and time stamps) from the user's operation of the pointing device 14 when operating the pointing device 14. For example, by moving an electronically displayed pointer graphic, and such pointer data may define how the user interacts with the pointing device 14. This interaction may be utilized for the creation of the different buckets (e.g., about hundreds of buckets), and accordingly to the categorization of each user into one of these buckets.

For example, with respect to the system shown in FIG. 1, the system may operate by processing the pointer interactions, essentially as follows: creating pointer data profiles based on initial user sessions (i.e., previous/historical user sessions) and storing the pointer data profiles in the form of pointer data profile entries in the pointer data profile database 15; performing user authentication using the stored pointer data profiles at the onset of subsequent user sessions, and continuously performing user authentication during the subsequent user sessions and during further user sessions. Such authentication operations may be particularly useful for controlling certain types of computerized access, e.g., to carry out a financial transaction, to access secure data, to run certain applications, and the like.

If authentication is unsuccessful, the authenticator module 16 may take remedial steps. In some arrangements, the authenticator module 16 may prompt a user for a stronger form of authentication. Additionally, in some arrangements, the authenticator module 16 may terminate the user session. Furthermore, in some arrangements, the authenticator module 16 may notify an administrator who may further initiate an investigation. These remedial steps may be performed in combination with each other, or be substituted with other activities, and so on.

Of course, there may be occurrences of legitimate users where the authentication may fail due to lack or limited pointer movements, in which case the user may re-try to authenticate in a subsequent user session.

All the above description and examples have been provided for the purpose of illustration and are not intended to limit the disclosure in any way, except as provided for in the appended claims.

1. A method of providing user profile detection from a pointing device, comprising the steps of:
creating, using at least one processor, a plurality of pointer data profiles based on initial user sessions;
storing the created pointer data profiles in the form of pointer data profile entries in a pointer data profile database, wherein each pointer data profile is based on collected user activity data generated by the pointing device; and
categorizing a user based on the stored pointer data profiles at an onset of a user session.

2. The method according to claim 1, further comprising continuously performing user categorization during subsequent user sessions.

3. The method according to claim 1, further comprising controlling at least one type of computer access based on the categorization.

4. The method according to claim 1, wherein the collected user activity data are parameters that represent raw mouse movement events and raw mouse operation events.

5. A computer readable medium that stores instruction executable by one or more processors to perform a method of providing user profile detection from a pointing device, comprising instructions for:
creating, using at least one processor, a plurality of pointer data profiles based on initial user sessions;
storing the created pointer data profiles in the form of pointer data profile entries in a pointer data profile database, wherein each pointer data profile is based on collected user activity data generated by the pointing device; and
categorizing a user based on the stored pointer data profiles at an onset of a user session.
